(19) United States
(12) Patent Application Publication
(10) Pub. No.: US 2024/0409070 A1
(43) Pub. Date: Dec. 12, 2024

(54) INTEGRATED BRAKE SYSTEM AND METHOD OF CONTROLLING THE SAME

(71) Applicant: HL MANDO CORPORATION, Gyeonggi-do (KR)

(72) Inventors: Kawnseek KIM, Gyeonggi-do (KR); Chang woo LEE, Gyeonggi-do (KR)

(21) Appl. No.: 18/419,554

(22) Filed: Jan. 23, 2024

(30) Foreign Application Priority Data
Jun. 7, 2023 (KR) 10-2023-0072922

(51) Int. Cl. B60T 8/171; B60T 8/172; B60T 13/14; B60T 13/68; B60T 13/74

(52) U.S. Cl. CPC B60T 8/171; B60T 8/172; B60T 13/142; B60T 13/686; B60T 13/745; B60T 2220/04; B60T 2270/402; B60T 2270/413

(57) ABSTRACT

An integrated brake system and a method of controlling the same are disclosed. According to an aspect of the present disclosure, an integrated brake system includes a remote control utility (RCU) module fluidly connected to a wheel brake coupled to a wheel; and an integrated dynamic brake (IDB) module fluidly connected to the RCU module and providing a transfer force to a fluid to be transferred to the wheel brake, the IDB module including a motor providing the transfer force to the fluid; and an IDB PCB electrically connected to the motor to control the motor, and the RCU module including an RCU PCB electrically connected to the motor to control the motor if the DDB PCB is in an inoperable state.

### CROSS-REFERENCE TO RELATED APPLICATION

This application claims priority to and the benefit of Korean Patent Application No. 10-2023-0072922, filed on Jun. 7, 2023, the disclosures of which is incorporated herein by reference in its entirety.

### FIELD

The present disclosure relates to an integrated brake system and a method of controlling the same, and more particularly, to an integrated brake system capable of stable braking control even if one component of the brake system malfunctions and a method of controlling the same.

### BACKGROUND

As technologies related to driving of vehicles develops, technologies for stably performing driving while minimizing intervention of a driver are being introduced.

In general, technologies referred to as autonomous driving technologies aim to perform safe driving by immediately reflecting various environments around a vehicle being driven and various variables that may occur during driving.

One example of the autonomous driving technologies may be a technology related to braking of a vehicle. If pedestrians or other vehicles are located in the vicinity of the vehicle being driven, or unexpected obstacles appear, the vehicle must be decelerated or stopped to minimize the impact on the driver. The technology related to braking of the vehicle is configured to perform such an operation.

To this end, the vehicle may include an electronic component as well as a mechanical component. The mechanical component has an advantage of being able to react immediately according to the driver's needs, but there is a limitation in that it is difficult to actively respond to various variables that may occur during driving of the vehicle. Accordingly, techniques for including the electronic component in the mechanical component or performing a role related to braking of a vehicle using only the electronic component are recently introduced.

On the other hand, the electronic component has a higher risk of malfunctioning compared to the mechanical component. Therefore, when braking of the vehicle is performed by the electronic component, operational reliability may be a problem. That is, when a singular component for braking a vehicle is provided, if the component malfunctions, the braking of the vehicle is impossible.

Accordingly, in the case of a vehicle in which braking is performed electronically, an additional component for braking is generally provided for a preliminary use.

Japanese Laid-Open Patent Application No 2023-038213 discloses a control system and a control method for a vehicle. In particular, the control system and the control method for a vehicle are disclosed, wherein the vehicle includes a first braking means operated by a first driving control means and a second driving means operated by a second driving control means, so that braking can be performed in multiple stages.

By the way, the control system and control method for a vehicle disclosed in the related technology documents are independently provided with the first braking means and the second braking means, and are also provided with a power source for controlling them, respectively. Therefore, there is a concern that the arrangement of components and the structure for electrical connection may become complicated.

Korean Laid-Open Patent Application No 10-2023-0036631 discloses a driving assistance system and a method of operating the same. Specifically, the driving assistance system and the method of operating the same are disclosed to detect a change in acceleration of a vehicle using control information on a braking device acquired by a sensor module, and to operate the braking device if the detecting result satisfies a specific condition.

However, the driving assistance system and the method of operating the same disclosed in the related technology document are configured to use only a single braking device. Therefore, there is a limitation in that it does not provide a countermeasure for a case where the braking device itself malfunctions.
(Patent document 1) Japanese Laid-Open Patent Application No 2023-038213 (2023 Mar. 16.)
(Patent document 2) Korean Laid-Open Patent Application No 10-2023-0036631 (2023 Mar. 15.)

### SUMMARY

The present disclosure has been made in view of the above problems, and an object of the present disclosure is to provide an integrated brake system and a method of controlling the same, in which braking reliability can be improved.

Another object of the present disclosure is to provide an integrated brake system and a method of controlling the same, in which a component for providing a transfer force to a fluid for braking can be controlled by at least two different components.

Still another object of the present disclosure is to provide an integrated brake system and a method of controlling the same, in which braking can be stably performed even if any one of the different components is malfunctioned.

Still another object of the present disclosure is to provide an integrated brake system and a method of controlling the same, in which miniaturization and manufacturing cost reduction are possible.

Still another object of the present disclosure is to provide an integrated brake system and a method of controlling the same, in which a structure for fluid connection between each component can be easily formed.

The present disclosure is not limited to the above-mentioned tasks, and other tasks not mentioned will be clearly understood by those skilled in the art from the following description.

According to an aspect of the present disclosure, there is provided an integrated brake system including: an RCU module fluidly connected to a wheel brake coupled to a wheel; and an IDB module fluidly connected to the RCU module and providing a transfer force to a fluid to be transferred to the wheel brake, the IDB module comprising: a motor providing the transfer force to the fluid; and an IDB PCB electrically connected to the motor to control the motor, and the RCU module comprising an RCU PCB electrically connected to the motor to control the motor based on an inoperable state of the IDB PCB.

In this case, there may be provided an integrated brake system in which the IDB module includes an IDB flow path fluidly connected to the motor and through which the fluid flows; and an IDB valve positioned in a part of the IDB flow path and electrically connected to the IDB PCB and controlled by the IDB PCB, and wherein the RCU module includes an RCU flow path fluidly connected to the IDB flow path and the wheel brake and through which the fluid flows.

In addition, there may be provided an integrated brake system including a direct flow path fluidly connected to another part of the IDB flow path and the RCU flow path to constitute a passage through which the fluid flows to the RCU flow path via the other portion of the IDB flow path.

In this case, there may be provided an integrated brake system in which the IDB flow path includes a motor flow path fluidly connected to the motor; a main transfer flow path fluidly connected to the motor flow path and having a part of the IDB valve positioned thereon; and a sub transfer flow path fluidly connected to the main transfer flow path and the RCU flow path and having another part of the IDB valve positioned thereon.

In addition, there may be provided an integrated brake system including a direct flow path fluidly connected to the motor flow path, and wherein the RCU module includes an RCU emergency flow path fluidly connected to the direct flow path.

In this case, there may be provided an integrated brake system including a direct flow path fluidly connecting the motor and the RCU module, wherein the RCU module includes an RCU external flow path fluidly connected to an IDB flow path of the IDB module; an RCU internal flow path fluidly connected to the RCU external flow path and the wheel brake, respectively; and an RCU emergency flow path fluidly connected to the direct flow path.

In addition, there may be provided an integrated brake system in which the RCU module includes an RCU internal valve disposed in the RCU internal flow path and configured to partially open and close the RCU internal flow path to form a hydraulic pressure that causes the fluid to flow.

In this case, there may be provided an integrated brake system in which the IDB module includes a brake coupled to a pedal and electrically connected to the IDB PCB, and the IDB PCB computes a control signal for controlling the motor using a pressing signal generated by pressing the pedal.

In addition, there may be provided an integrated brake system in which the brake includes a piston coupled to the pedal; a cylinder movably accommodating the piston and containing the fluid therein; and a brake flow path fluidly connected to the cylinder and the RCU module, respectively, to constitute a flow path through which the fluid flows to the RCU module.

In this case, there may be provided an integrated brake system in which the brake includes a brake valve positioned on the brake flow path and configured to control a flow direction of the fluid such that the fluid flows only in the direction from the cylinder toward the RCU module.

In addition, according to an aspect of the present disclosure, there is provided a method for controlling an integrated brake system, including (a) generating, with a motor, a hydraulic pressure; (b) allowing a fluid to flow in an IDB module using the generated hydraulic pressure; (c) allowing the fluid to flow in an RCU module fluidly connected to the IDB module; and (d) transferring the fluid to a wheel fluidly connected to at least one of the IDB module and the RCU module to brake the wheel, wherein the motor is controlled by at least one of an IDB PCB provided in the IDB module and an RCU PCB provided in the RCU module.

In this case, there may be provided a method for controlling an integrated brake system in which (a) generating the hydraulic pressure includes (a1) applying, with the IDB PCB, a control signal to the motor; and (a2) operating the motor according to the control signal to generate the hydraulic pressure.

In addition, there may be provided a method for controlling an integrated brake system in which (a) generating the hydraulic pressure further includes before (a1) applying the control signal to the motor, (a01) pressurizing a pedal; and (a02) transmitting a pressing signal to the IDB PCB using a brake connected to the pedal, wherein the IDB PCB computes the control signal using the pressing signal applied.

In this case, there may be provided a method for controlling an integrated brake system in which (a) generating the hydraulic pressure includes (a3) detecting a state of the IDB PCB; (a4) applying, with the RCU PCB, a control signal to the motor if the IDB PCB is in an inoperable state; and (a5) operating the motor according to the control signal to generate the hydraulic pressure.

In addition, there may be provided a method for controlling an integrated brake system in which (b) allowing the fluid to flow in the IDB module includes (b1) allowing the fluid to flow in a motor flow path fluidly connected to the motor; (b2) allowing the fluid to flow in a main transfer flow path fluidly connected to the motor flow path; and (b3) allowing the fluid to flow in a sub transfer flow path fluidly connected to the main transfer flow path.

In this case, there may be provided a method for controlling an integrated brake system in which (b) allowing the fluid to flow in the IDB module includes (b4) allowing the fluid to flow in a motor flow path fluidly connected to the motor; and (b5) allowing the fluid to flow in a direct flow path fluidly connected to the motor flow path.

In addition, there may be provided a method for controlling an integrated brake system in which (c) allowing the fluid to flow in the RCU module includes (c1) allowing the fluid to flow in an RCU external flow path fluidly connected to the IDB module; and (c2) allowing the fluid to flow in an RCU internal flow path fluidly connected to the RCU external flow path.

In this case, there may be provided a method for controlling an integrated brake system in which (c) allowing the fluid to flow in the RCU module includes: (c3) allowing the fluid to flow in an RCU emergency flow path fluidly connected to the direct flow path; and (c4) allowing the fluid to flow in an RCU internal flow path fluidly connected to the RCU emergency flow path.

In addition, there may be provided a method for controlling an integrated brake system in which (d) transferring the fluid to the wheel includes (d1) allowing a part of the fluid to flow in a part of a wheel connection flow path fluidly connected to an RCU internal flow path; (d2) allowing a remainder of the fluid to flow in a remaining wheel connection flow path of fluidly connected to the IDB module; and (d3) transferring the fluid to a wheel brake fluidly connected to the wheel connection flow path to limit rotation of the wheel.

In this case, there may be provided a method for controlling an integrated brake system in which (d) transferring the fluid to the wheel includes (d4) allowing the fluid to flow in a wheel connection flow path fluidly connected to a RCU internal flow path; and (d5) transferring the fluid to a wheel brake fluidly connected to the wheel connection flow path to limit rotation of the wheel.

According to the above configuration, by the integrated brake system and the method of controlling the same according to the embodiment of the present disclosure, braking reliability may be improved

Further, according to the above configuration, by the integrated brake system and the method of controlling the same according to the embodiment of the present disclosure, the component for providing the transfer force to the fluid for braking may be controlled by at least two different components.

Further, according to the above configuration, by the integrated brake system and the method of controlling the same according to the embodiment of the present disclosure, braking can be stably performed even if any one of the different components is malfunctioned.

Further, according to the above configuration, by the integrated brake system and the method of controlling the same according to the embodiment of the present disclosure, miniaturization and manufacturing cost reduction may be possible.

Further, according to the above configuration, by the integrated brake system and the method of controlling the same according to the embodiment of the present disclosure, a structure for fluid connection between each component may be easily formed.

It should be understood that the effects of the present disclosure are not limited to the above effects, and include all effects that can be inferred from the components of the invention described in the detailed description or the claims of the present disclosure.

### BRIEF DESCRIPTION OF THE DRAWINGS

FIG. 1 is a block diagram illustrating a configuration of an integrated brake system according to an embodiment of the present disclosure.

FIG. 2 is a block diagram illustrating a configuration of an IDB module provided in the integrated brake system of FIG. 1.

FIG. 3 is a block diagram illustrating a configuration of an RCU module provided in the integrated brake system of FIG. 1.

FIG. 4 is a block diagram illustrating an electrical connection relationship between a motor provided in the integrated brake system of FIG. 1 and a plurality of PCBs.

FIGS. 5 and 6 are conceptual diagrams illustrating a connection relationship between each configuration of the integrated brake system of FIG. 1.

FIGS. 7 and 8 are use state diagrams illustrating a flow of a fluid when the integrated brake system of FIG. 1 is operated in a first state.

FIGS. 9 and 10 are use state diagrams illustrating a flow of a fluid when the integrated brake system of FIG. 1 is operated in a second state.

FIG. 11 is a flowchart illustrating a flow of a method for controlling an integrated brake system according to an embodiment of the present disclosure.

FIG. 12 is a flowchart illustrating a detailed flow of step S100 of a method for controlling the integrated brake system of FIG. 11.

FIG. 13 is a flowchart illustrating a detailed flow of step S200 of a method for controlling the integrated brake system of FIG. 11.

FIG. 14 is a flowchart illustrating a detailed flow of step S300 of a method for controlling the integrated brake system of FIG. 11.

FIG. 15 is a flowchart illustrating a detailed flow of step S400 of a method of controlling the integrated brake system of FIG. 11.

### DETAILED DESCRIPTION OF EXEMPLARY EMBODIMENTS

Hereinafter, embodiments of the present disclosure will be described in detail with reference to the accompanying drawings so that those skilled in the art can easily carry out the present disclosure. The present disclosure may be embodied in various different forms and is not limited to the embodiments described herein. In order to clearly describe the present disclosure, parts not related to the description are omitted in the drawings, and the same or similar components are denoted by the same reference numerals throughout the specification.

The words and terms used in the specification and the claims are not to be construed as limited to ordinary or dictionary meanings, but should be construed as meanings and concepts corresponding to technical aspects of the present disclosure according to principles capable of defining terms and concepts by the inventor in order to describe the present disclosure in a best way.

Therefore, the embodiments described in the specification and the configurations illustrated in the drawings correspond to a preferred embodiment of the present disclosure and do not represent all the technical aspects of the present disclosure, and thus the corresponding configurations may have various equivalents and modifications to substitute them at the time of filing the present disclosure.

In the following description, some components may be omitted to clarify the features of the present disclosure.

The term “passage” used in the following description means that one or more members are connected to each other so as to be fluidly communicated. In an embodiment, the passage may be formed by a member such as a conduit, a pipe, and a plumbing. In the following description, the passage may be used as meaning that one or more members are “fluidly connected” to each other.

The term “electrical connection” used in the following description means that one or more members are connected to each other so as to transmit a current or an electric signal. In an embodiment, the electrical connection may be formed in a wired form by a wire member or the like or in a wireless form such as Bluetooth, Wi-Fi, or RFID. In an embodiment, the electrical connection may include the meaning of “communication”.

The term “fluid” used in the following description means any type of material that is flowed by transferring force and may deform a shape or volume. In an embodiment, the fluid may be a liquid such as water or a gas such as air.

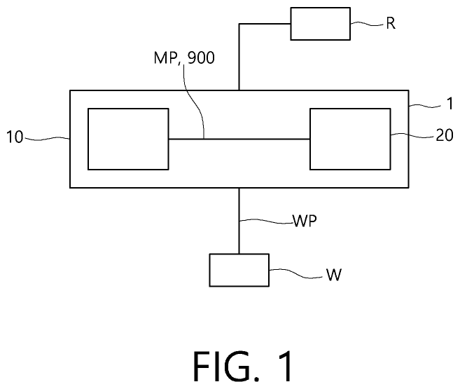

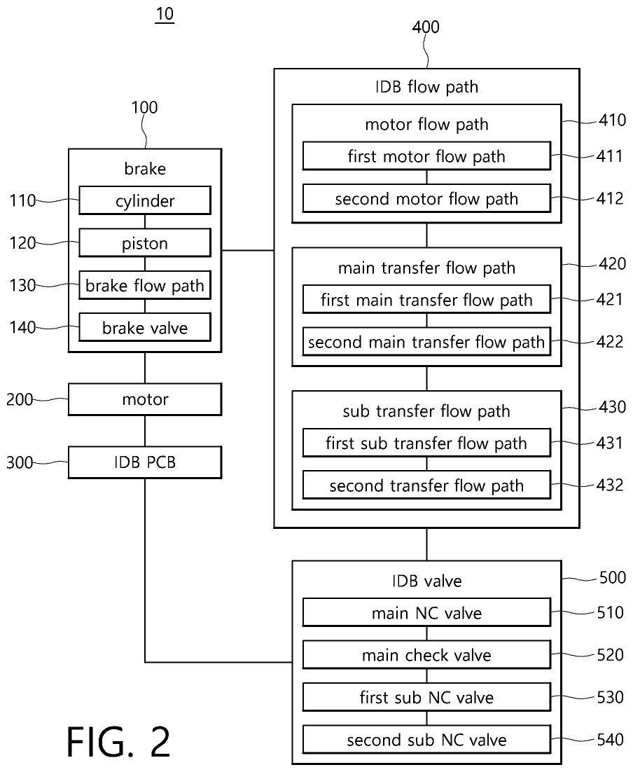

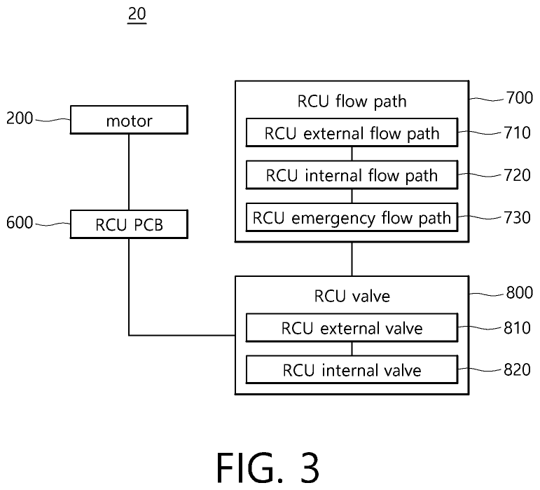

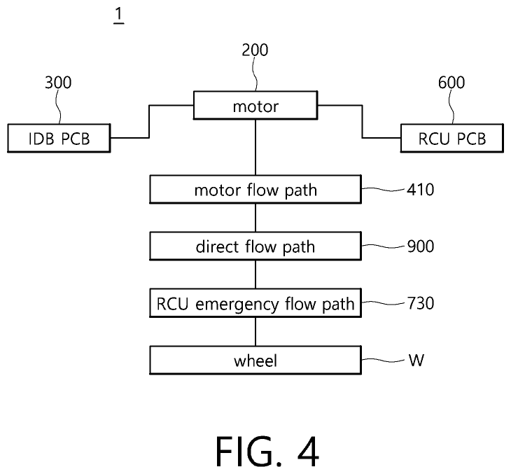

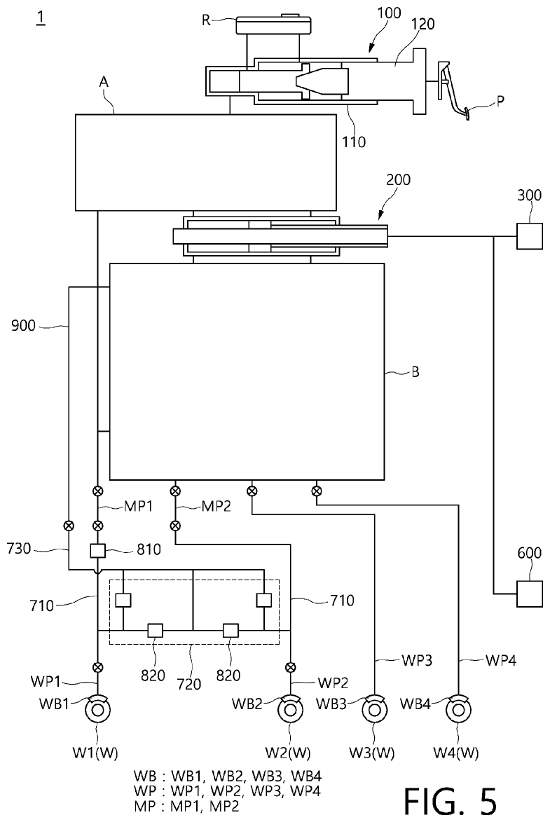

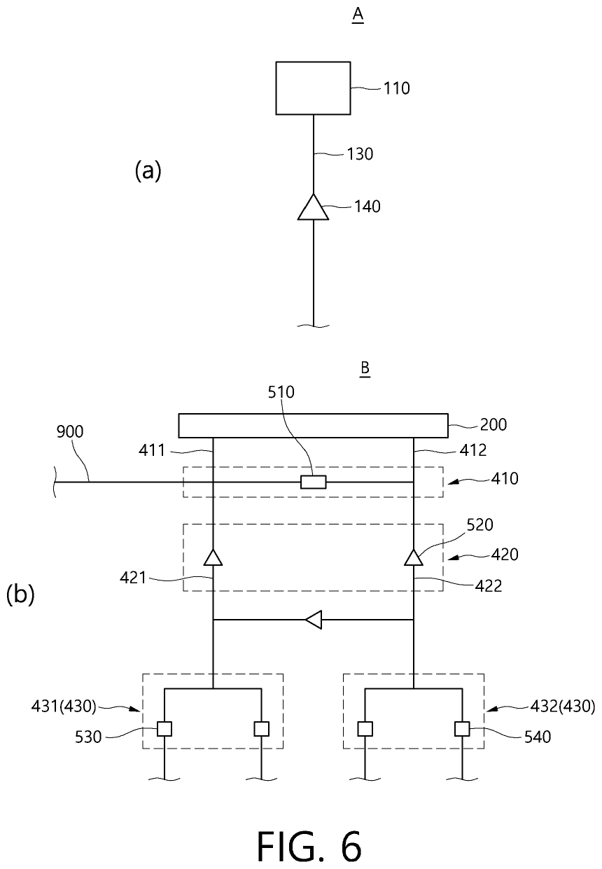

Referring to FIGS. 1 to 6, components and connection relationships of an integrated brake system 1 according to an embodiment of the present disclosure are illustrated.

The integrated brake system 1 may be provided in a vehicle and utilized to brake driving of the vehicle. In this case, the integrated brake system 1 may be operated in an electronic form.

In an embodiment, the integrated brake system 1 may be configured to brake the vehicle by rotating a wheel W provided in the vehicle in a reverse direction. In another embodiment, the integrated brake system 1 may be configured to limit rotation of the wheel W by supplying a fluid to a wheel brake WB provided in the wheel W.

In an embodiment, the integrated brake system 1 may be provided in a vehicle capable of autonomous driving. In the above embodiment, the integrated brake system 1 may be manually operated by a user's operation. In addition, in the above embodiment, the integrated brake system 1 may be actively operated according to a state of the vehicle being driven or a surrounding environment.

The integrated brake system 1 according to an embodiment of the present disclosure may include a plurality of components for braking a vehicle. In the illustrated embodiment, the integrated brake system 1 includes an IDB module 10 and an RCU module 20.

The integrated dynamic brake (IDB) module 10 may generate a braking pressure by directly driving the pressure piston using the motor 200 to be described later. Thus, the IDB module 10 may be referred to as an integrated brake device or module.

In the illustrated embodiment, the IDB module 10 includes a brake 100, a motor 200, an IDB PCB 300, an IDB flow path 400, and an IDB valve 500.

The brake 100 is operated by a user. In an embodiment, the brake 100 may be connected to a pedal P and may be received with pressure applied by the user. If the pressure is applied to the brake 100, it is converted into an electrical signal and transmitted to the motor 200. The motor 200 may be operated according to the electrical signal to form the braking pressure. Accordingly, fluid may be transferred to the wheel brake WB via the other components of the IDB module 10 and the RCU module 20 to limit rotation of the wheel W.

A user who pressurizes the pedal P may feel resistance due to a pressure of a predetermined fluid because a predetermined fluid is contained in the brake 100. In a burst situation, the predetermined fluid contained in the brake 100 may be transferred to the RCU module 20 and utilized to limit the rotation of the wheel W.

The brake 100 is fluidly connected to a reservoir R. The fluid contained in the brake 100 may be transferred from the reservoir R.

The brake 100 is fluidly connected to the RCU module 20. The fluid contained in the brake 100 may be transferred to the RCU module 20.

The brake 100 is connected to the pedal P. Some components (i.e., the piston 120 to be described below) of the brake 100 may be moved by pressure applied to the pedal P.

The brake 100 is electrically connected to the IDB PCB 300. If a pressing signal indicating that the pedal P is pressurized is generated, the IDB PCB 300 may control the motor 200 to correspond to the generated pressing signal. Accordingly, the user may feel that braking of the vehicle is performed by pressurizing the pedal P.

In the illustrated embodiment, the brake 100 includes a cylinder 110, a piston 120, a brake flow path 130, and a brake valve 140.

The cylinder 110 constitutes an outer shape of the brake 100. The cylinder 110 moveably accommodated the piston 120. A space for movably accommodating the piston 120 is formed inside the cylinder 110. The predetermined fluid may be at least partially contained in the space.

The cylinder 110 may constitute the outer shape of the brake 100 and may have any shape capable of movably accommodating the piston 120. In the illustrated embodiment, the cylinder 110 has a circular cross-section and is a cylindrical shape elongated in one direction.

The piston 120 is moved according to the pressure applied by the user to the pedal P. The piston 120 is coupled to the pedal P and movably accommodated in the cylinder 110.

The piston 120 may be positioned at least partially outside the cylinder 110. A portion of the piston 120 positioned outside the cylinder 110 may be coupled to the pedal P.

At this time, between the portion of the piston 120 and the cylinder 110, an arbitrary member may be provided to provide a restoring force for the piston 120 moved by pressing the pedal P to return to the original position. In the illustrated embodiment, the arbitrary member is provided as a coil spring.

The brake flow path 130 fluidly connects the internal space of the cylinder 110 to the IDB flow path 400 and a RCU flow path 700. The predetermined fluid contained in the cylinder 110 may be transferred to the IDB flow path 400 or the RCU flow path 700 through the brake flow path 130. In the illustrated embodiment, the brake flow path 130 is fluidly connected to a sub transfer flow path 430 and a RCU external flow path 710.

In this case, the fluid may flow from the inside of the cylinder 110 to the IDB flow path 400 or the RCU flow path 700, and the flow may be restricted in a direction opposite to the direction. To this end, the brake valve 140 is provided on the brake flow path 130.

The brake valve 140 is configured to restrict the flow direction of the fluid flowing in the brake flow path 130. As described above, the fluid may only flow in the direction from the inside of the cylinder 110 toward the IDB flow path 400 or the RCU flow path 700. The brake valve 140 may be provided on the brake flow path 130 to block the flow of the fluid in a direction different from the direction.

The brake valve 140 may be provided in any form capable of limiting the flow direction of the fluid. In an embodiment, the brake valve 140 may be provided in the form of a check valve.

The motor 200 provides a transfer force for the fluid to flow. The motor 200 may generate hydraulic pressure to allow the fluid contained in the IDB module 10 to flow out to the IDB flow path 400. The fluid may be transferred to the wheel brake WB via the IDB flow path 400 and the RCU flow path 700 or a wheel connection flow path WP.

The motor 200 may be provided in any form capable of generating the hydraulic pressure for flowing fluid. In an embodiment, the motor 200 may be provided in the form of a three-phase motor.

The motor 200 is electrically connected to the IDB PCB 300. The motor 200 may be operated by a control signal applied by the IDB PCB 300. As described above, the pressing signal generated by pressing the pedal P may be transmitted to the IDB PCB 300. The IDB PCB 300 may control driving of the motor 200 according to the pressing signal, and as a result, may control the flow of the fluid.

In addition, the integrated brake system 1 according to the embodiment of the present disclosure enables the motor 200 to be electrically connected to the RCU PCB 600. The motor 200 may be operated by the control signal applied by the RCU PCB 600. In this case, the RCU PCB 600 may be configured to apply the control signal to the motor 200 if the IDB PCB 300 malfunctions.

Accordingly, the motor 200 provided in the integrated brake system 1 according to the embodiment of the present disclosure may be controlled by the IDB PCB 300 in a general state, and may be controlled by the RCU PCB 600 in a second situation, that is, a situation in which the IDB PCB 300 is inoperative. As a result, operation reliability of the motor 200 may be improved and braking performance and reliability of the vehicle may also be improved.

The motor 200 is fluidly connected to the IDB flow path 400. The fluid may flow toward the IDB flow path 400 by the hydraulic pressure generated by the motor 200.

The IDB PCB 300 computes control signals for controlling various components provided in the IDB module 10. The IDB PCB 300 may control the various components according to the computed control signals. In other words, the IDB PCB 300 is configured to control each component for braking the vehicle.

The IDB PCB 300 may be provided in any form capable of computing control signals, being electrically connected to each component of the IDB module 10, and controlling each component. The IDB PCB 300 In an embodiment, the IDB PCB 300 may be provided in the form of a PCB module (Printed Circuit Board) module or a PBA (Printed Board Assembly) module.

The IDB PCB 300 may compute the control signals. The IDB PCB 300 may calculate the compute signals using information detected by various sensors (not shown) provided in the vehicle. For example, the IDB PCB 300 may compute the control signals based on a distance to a vehicle or an obstacle located in front of a vehicle being driven, a target speed previously input by a user, and the like.

The IDB PCB 300 is electrically connected to the brake 100. The IDB PCB 300 may receive a pressing signal generated if the pedal P is pressed. The IDB PCB 300 may compute the control signals using the received pressing signal.

The IDB PCB 300 is electrically connected to the motor 200. The IDB PCB 300 may control operation of the motor 200 to correspond to the generated control signals. Accordingly, driving or braking of the vehicle may be controlled.

The IDB PCB 300 is electrically connected to the IDB valve 500. The IDB PCB 300 may control operation of the IDB valve 500 to correspond to the generated control signals. Accordingly, whether the flow of the fluid is formed and the direction of the flow can be controlled.

In an embodiment, the IDB PCB 300 may be electrically connected to the RCU PCB 600. In the above embodiment, the IDB PCB 300 and the RCU PCB 600 may be configured to detect operating states of each other. If the IDB PCB 300 malfunctions, the state may be detected by the RCU PCB 600 and the RCU PCB 600 may directly control the motor 200.

The IDB flow path 400 constitutes a passage through which fluid flows. The IDB flow path 400 fluidly connects the IDB module 10 to the outside. In addition, the IDB flow path 400 fluidly connects each component of the IDB module 10.

The IDB flow path 400 may be provided in any form capable of forming a fluid passage. In an embodiment, the IDB flow path 400 may be provided in the form of a pipe, a hose, or the like.

The IDB flow path 400 may include a plurality of components. Some of the plurality of components may fluidly connect the IDB module 10 to the RCU module 20 or another component of the vehicle. The remainder of the plurality of components may fluidly connect each component provided in the IDB module 10.

In the illustrated embodiment, the IDB flow path 400 includes a motor flow path 410, a main transfer flow path 420, and a sub transfer flow path 430.

The motor flow path 410 constitutes a part of the IDB flow path 400. The motor flow path 410 fluidly connects the motor 200 and the remainder of the IDB flow path 400. In the illustrated embodiment, the motor flow path 410 fluidly connects the motor 200 to the main transfer flow path 420 and the sub transfer flow path 430.

In addition, the motor flow path 410 fluidly connects the motor 200 and the direct flow path 900. In a situation where the IDB PCB 300 is inoperative and thus the IDB valve 500 is not controllable, the fluid may be transferred to the RCU flow path 700 via the motor flow path 410 and the direct flow path 900.

A plurality of motor flow paths 410 may be provided. The plurality of motor flow paths 410 may independently constitute a fluid flow path. In the illustrated embodiment, the motor flow path 410 includes a first motor flow path 411 and a second motor flow path 412.

The first motor flow path 411 fluidly connects the motor 200 to the first main transfer flow path 421 and the direct flow path 900. The second motor flow path 412 fluidly connects the motor 200 to the second main transfer flow path 422.

As will be described later, the first main transfer flow path 421 and the second main transfer flow path 422 may be selectively communicated by the main check valve 520. Accordingly, it may be said that both the first main transfer flow path 421 and the second main transfer flow path 422 communicate with the direct flow path 900.

The first motor flow path 411 and the second motor flow path 412 may selectively communicate with each other. A main NC valve 510 may be provided on a flow path connecting the first motor flow path 411 and the second motor flow path 412. According to the opening and closing of the main NC valve 510, communication between the first motor flow path 411 and the second motor flow path 412 may be permitted or blocked.

The main transfer flow path 420 constitutes another part of the IDB flow path 400. The main transfer flow path 420 fluidly connects the motor flow path 410 to the remainder of the IDB flow path 400. In the illustrated embodiment, the main transfer flow path 420 fluidly connects the motor flow path 410 and the sub transfer flow path 430.

A plurality of main transfer flow paths 420 may be provided. The plurality of main transfer flow paths 420 may communicate the plurality of motor flow paths 410 with the plurality of sub transfer flow paths 430, respectively. In the illustrated embodiment, the main transfer flow path 420 includes a first main transfer flow path 421 and a second main transfer flow path 422.

The first main transfer flow path 421 communicates the first motor flow path 411 with the first sub transfer flow path 431. The fluid passing through the first motor flow path 411 may flow to the first sub transfer flow path 431 through the first main transfer flow path 421. As will be described later, the fluid passing through the first sub transfer flow path 431 may be transferred to the first wheel brake WB1 and the second wheel brake WB2 coupled to the first wheel W1 and the second wheel W2, respectively.

The second main transfer flow path 422 communicates the second motor flow path 412 with the second sub transfer flow path 432. The fluid passing through the second motor flow path 412 may flow to the second sub transfer flow path 432 through the second main transfer flow path 422. As will be described later, the fluid passing through the second sub transfer flow path 432 may be transferred to the third wheel brake WB3 and the fourth wheel brake WB4 coupled to the third wheel W3 and the fourth wheel W4, respectively.

The first main transfer flow path 421 and the second main transfer flow path 422 may be selectively communicated. A main check valve 520 may be provided in the first main transfer flow path 421 and the second main transfer flow path 422. The main check valve 520 may control a flow direction of the fluid flowing in the first main transfer flow path 421 and the second main transfer flow path 422.

The sub transfer flow path 430 constitutes the remainder of the IDB flow path 400. The sub transfer flow path 430 fluidly connects the main transfer flow path 420 to the RCU module 20 or the wheel brake WB. In the illustrated embodiment, the sub transfer flow path 430 communicates the main transfer flow path 420 with the first and second module connection flow paths MP1 and MP1 and the third and fourth wheel connection flow paths WP3 and WP4.

A plurality of sub transfer flow paths 430 may be provided. The plurality of sub transfer flow paths 430 may connect the plurality of main transfer flow paths 420 to the plurality of module connection flow paths MP or the plurality of wheel connection flow paths WP, respectively. In the illustrated embodiment, the sub transfer flow paths 430 includes a first sub transfer flow path 431 and a second sub transfer flow path 432.

The first sub transfer flow path 431 is fluidly connected to the first main transfer flow path 421. The fluid flowing through the first main transfer flow path 421 may be transferred to the first sub transfer flow path 431.

The first sub transfer flow path 431 may include a plurality of branched flow paths. The fluid introduced into the first sub transfer flow path 431 may flow along the branched flow paths and may be discharged to the plurality of module connection flow paths MP.

The first sub transfer flow path 431 is fluidly connected to the module connection flow path MP. The fluid introduced into the first sub transfer flow path 431 may be delivered to the RCU module 20 through the module connection flow path MP. As will be described later, the RCU module 20 is fluidly connected to the first and second wheels W1 and W2 or the first and second wheel brakes WB1 and WB2 among the plurality of the wheels W or the wheel brake WB.

Accordingly, it can be said that the first sub transfer flow path 431 may be fluidly connected to the first and second wheels W1 and W2 or the first and second wheel brakes WB1 and WB2.

The second sub transfer flow path 432 is fluidly connected to the second main transfer flow path 422. The fluid flowing through the second main transfer flow path 422 may be transferred to the second sub transfer flow path 432.

The second sub transfer flow path 432 may include a plurality of branched flow paths. The plurality of fluids introduced into the second sub transfer flow path 432 may flow along the branched flow paths and may be discharged to the plurality of wheel connection flow paths WP.

The second sub transfer flow path 432 is fluidly connected to the wheel connection flow path WP. The fluid introduced into the second sub transfer flow path 432 may directly flow to the wheel connection flow path WP and may flow to the plurality of wheels W or wheel brakes WB. Accordingly, the second sub transfer flow path 432 may be directly fluidly connected to the plurality of wheels W or wheel brakes WB.

In the illustrated embodiment, the second sub transfer flow path 432 is fluidly connected to the third and fourth wheel connection flow paths WP3 and WP4. The fluid delivered to the second sub transfer flow path 432 is transferred to the third and fourth wheels W3 and W4, or the third and fourth wheel brakes WB3 and WB4.

Therefore, it can be said that the second sub transfer flow path 432 may be said to be fluidly connected to the third and fourth wheels W3 and W4, or the third and fourth wheel brakes WB3 and WB4.

The IDB valve 500 is disposed on the IDB flow path 400 to control the flow path of fluid flowing in the IDB flow path 400. The IDB valve 500 may be configured to form or dissipate a flow path of a fluid or control a flow direction of the fluid.

The IDB valve 500 is electrically connected to the IDB PCB 300. The IDB valve 500 may be operated according to the control signal applied to the IDB PCB 300.

The IDB valve 500 is coupled to the IDB flow path 400. The IDB valve 500 may control the flow of fluid flowing in the IDB flow path 400.

The IDB valve 500 may be provided in any form that may be operated according to the control signal applied to the IDB PCB 300. In an embodiment, the IDB valve 500 may be provided in the form of a solenoid valve.

A plurality of IDB valves 500 may be provided. The plurality of IDB valves 500 may be provided in each component of the IDB flow path 400 to form and dissipate a flow path or control a flow direction of the fluid.

In the illustrated embodiment, the IDB valve 500 includes a main NC valve 510, a main check valve 520, a first sub NC valve 530, and a second sub NC valve 540.

The main NC (Normal Close) valve 510 is positioned in the motor flow path 410. Specifically, the main NC valve 510 is positioned on a flow path that fluidly connects the first motor flow path 411 and the second motor flow path 412.

The main NC valve 510 may open or close the flow path. As can be seen from the name, in a first situation, the main NC valve 510 may close the flow path. In the second situation, the main NC valve 510 may open the flow path.

Further, as described above, the first motor flow path 411 communicates with the direct flow path 900. The main NC valve 510 may open or close the flow path such that the fluid introduced into the first motor flow path 411 flows to the direct flow path 900. This will be described in detail below.

A plurality of main NC valves 510 may be provided. The plurality of main NC valves 510 may permit or block communication between the first motor flow path 411 and the second motor flow path 412 at different positions. The plurality of main NC valves 510 may permit or block communication between the first motor flow path 411 and the second motor flow path 412 independently of each other.

The main check valve 520 is positioned in the main transfer flow path 420. Specifically, the main check valve 520 is positioned on the first main transfer flow path 421, the second main transfer flow path 422, and the flow paths connecting them. The main check valve 520 may control a flow direction of a fluid flowing in the main transfer flow path 420.

A plurality of main check valves 520 may be provided. The plurality of main check valves 520 may be disposed at different positions to control the flow direction of the fluid, respectively.

In the illustrated embodiment, a total of six main check valves 520 are provided. Two main check valves 520 are disposed in the first main transfer flow path 421 and two main check valves 520 are disposed in the second main transfer flow path 422. The remaining two main check valves 520 are positioned on flow paths communicating the first main transfer flow path 421 and the second main transfer flow path 422.

The first sub NC valve 530 is positioned in the first sub transfer flow path 431. Specifically, the first sub NC valve 530 is positioned in a plurality of flow paths where the first sub transfer flow path 431 is branched.

The first sub NC valve 530 may open or close the flow path. In a first situation, the first sub NC valve 530 may close the flow path. In a second situation, the first sub NC valve 530 may open the flow path.

A plurality of first sub NC valves 530 may be provided. The plurality of first sub NC valves 530 may independently open or close the plurality of flow paths, respectively.

In the illustrated embodiment, four first sub NC valves 530 are provided. The two first sub NC valves 530 are positioned on flow paths connected to the first module connection flow path MP1 among the first sub transfer flow path 431. The other two first sub NC valves 530 are positioned on flow paths connected to the second module connection flow path MP2 among the first sub transfer flow path 431.

The second sub NC valve 540 is positioned in the second sub transfer flow path 432. Specifically, the second sub NC valve 540 is respectively positioned in a plurality of flow paths where the second sub transfer flow path 432 is branched.

The second sub NC valve 540 may open or close the flow path. In a first situation, the second sub NC valve 540 may close the flow path. In a second situation, the second sub NC valve 540 may open the flow path.

A plurality of second sub NC valves 540 may be provided. The plurality of second sub NC valves 540 may independently open or close the plurality of flow paths, respectively.

In the illustrated embodiment, four second sub NC valves 540 are provided. The two second sub-NC valves 540 are positioned on flow paths connected to the third wheel connection flow path WP3 among the second sub transfer flow path 432. The other two second sub-NC valves 540 are positioned on the flow paths connected to the fourth wheel connection flow path WP4 among the second sub transfer flow path 432.

Referring back to FIGS. 1 to 6, the integrated brake system 1 according to an embodiment of the present disclosure includes an RCU module 20.

An RCU (Remote Control Utility) module 20 is fluidly connected to the IDB module 10. The RCU module 20 may receive a fluid (i.e., a fluid applied to the wheel brake WB to brake the wheel W, hereinafter referred to as a fluid.) flowing by braking pressure generated by the IDB module 10. The RCU module 20 may be fluidly connected to the wheel brake WB to apply the transferred fluid to the wheel brake WB.

In this case, the RCU module 20 according to an embodiment of the present disclosure may be provided in the IDB module 10 and electrically connected to a component (i.e., the motor 200 to be described later) for generating a braking pressure. If a component (i.e., the IDB PCB 300 to be described later) provided in the IDB module 10 to control the motor 200 malfunctions, the RCU module 20 may directly control the motor 200.

Thus, the RCU module 20 may directly control the motor 200 in a redundant manner even if the IDB module 10 is inoperative. As a result, the operation reliability of the integrated brake system 1 is improved and the autonomous driving stability of the vehicle may also be improved.

A detailed description of a process in which braking is performed by the RCU module 20 if the IDB module 10 malfunctions will be described later.

In the illustrated embodiment, the RCU module 20 includes an RCU PCB 600, an RCU flow path 700, and an RCU valve 800.

The RCU PCB 600 computes control signals for controlling various components provided in the RCU module 20. The RCU PCB 600 may control the various components according to the computed control signals. In other words, the RCU PCB 600 is configured to control each component for braking the vehicle.

The RCU PCB 600 may be provided in any form capable of computing the control signals and controlling the respective components of the RCU module 20 by being electrically connected to the respective components. In an embodiment, the RCU PCB 600 may be provided in the form of a PCB module (Printed Circuit Board) module or a PBA (Printed Board Assembly) module.

The RCU PCB 600 may compute the control signals. The RCU PCB 600 may compute the control signals using information detected by various sensors (not shown) provided in the vehicle. For example, the RCU PCB 600 may compute the control signals based on a distance to a vehicle or an obstacle located in front of a vehicle being driven, a target speed previously input by a user, and the like.

The RCU PCB 600 is electrically connected to the motor 200. The RCU PCB 600 may control operation of the motor 200 to correspond to the generated control signals. Accordingly, driving or braking of the vehicle may be controlled.

In particular, the RCU PCB 600 may be configured to directly control the motor 200 if the IDB PCB 300 malfunctions. In other words, the RCU PCB 600 may take over the control authority of the motor 200 from the malfunctioning IDB PCB 300.

In an embodiment, the RCU PCB 600 may be electrically connected to the IDB PCB 300. The RCU PCB 600 and the IDB PCB 300 may detect operating states of each other. If an abnormality occurs in the operation of the IDB PCB 300, the RCU PCB 600 may directly control the motor 200.

The RCU PCB 600 is electrically connected to the RCU valve 800. The RCU PCB 600 may control operation of the RCU valve 800 to correspond to the generated control signal. Accordingly, whether the flow of the fluid is formed and the direction of the flow can be controlled.

The RCU flow path 700 constitutes a passage through which fluid flows. The RCU flow path 700 fluidly connects the RCU module 20 to the outside. In addition, the RCU flow path 700 fluidly connects each component of the RCU module 20.

The RCU flow path 700 may be provided in any form capable of forming a fluid passage. In an embodiment, the RCU flow path 700 may be provided in the form of a pipe, a hose, or the like.

The RCU flow path 700 may include a plurality of components. Some of the plurality of components may fluidly connect the RCU module 20 to the IDB module 10 or another component of the vehicle. The remainder of the plurality of components may fluidly connect each component provided in the RCU module 20.

In the illustrated embodiment, the RCU flow path 700 includes an RCU external flow path 710, an RCU internal flow path 720, and an RCU emergency flow path 730.

The RCU external flow path 710 constitutes a part of the RCU flow path 700. The RCU external flow path 710 fluidly connects the RCU module 20 to another component of the integrated brake system 1. In the illustrated embodiment, the RCU external flow path 710 fluidly connects a module connection flow path MP to the RCU internal flow path 720. In addition, the RCU external flow path 710 is connected to the wheel connection flow path WP and communicates with the wheel W or the wheel brake WB.

A plurality of RCU external flow paths 710 may be provided. The plurality of RCU external flow paths 710 may be fluidly connected to different RCU internal flow paths 720, the module connection flow path MP, and the wheel connection flow path WP, respectively.

In the illustrated embodiment, a pair of RCU external flow paths 710 are provided. Any one RCU external flow path 710 is fluidly connected to a first module connection flow path MP1 and a first wheel connection flow path WP1, respectively. The fluid passing through the first sub transfer flow path 431 may flow to the RCU internal flow path 720 or the first wheel connection flow path WP1 through the first module connection flow path MP1 and the any one RCU external flow path 710.

In addition, the other RCU external flow path 710 is fluidly connected to a second module connection flow path MP2 and a second wheel connection flow path WP2, respectively. The fluid passing through the second sub transfer flow path 432 may flow to the RCU internal flow path 720 or the second wheel connection flow path WP2 through the second module connection flow path MP2 and the other RCU external flow path 710.

The RCU internal flow path 720 constitutes another part of the RCU flow path 700. The RCU internal flow path 720 is fluidly connected to the RCU external flow path 710 and the RCU emergency flow path 730, respectively. The RCU internal flow path 720 may receive a fluid flowing through the RCU external flow path 710 or the RCU emergency flow path 730. The fluid flowing through the RCU internal flow path 720 may be transferred to the wheel connection flow path WP again through the RCU external flow path 710.

A plurality of RCU internal flow paths 720 may be provided. The plurality of RCU internal flow paths 720 may be fluidly connected to the RCU external flow path 710 and the RCU emergency flow path 730 at different positions.

The RCU emergency flow path 730 constitutes the remainder of the RCU flow path 700. The RCU emergency flow path 730 is fluidly connected to the RCU internal flow path 720 and the direct flow path 900, respectively. A fluid flowing along the direct flow path 900 may flow to the RCU internal flow path 720 through the RCU emergency flow path 730.

As described above, the RCU internal flow path 720 is fluidly connected to the RCU external flow path 710 so that a fluid may be transferred to the first wheel connection flow path WP1 or the second wheel connection flow path WP2.

Meanwhile, in the illustrated embodiment, four wheels W include first to fourth wheels W1, W2, W3, and W4. In addition, the first to fourth wheels W1, W2, W3, and W4 are coupled to first to fourth wheel brakes WB1, WB2, WB3, and WB4, respectively, and the first to fourth wheel brakes WB1, WB2, WB3, and WB4 are fluidly connected to first to fourth wheel connection flow paths WP1, WP2, WP3, and WP4.

In this case, the first and second wheel connection flow paths WP1 and WP2 are fluidly connected to the RCU module 20. Accordingly, it may be said that the first and second wheels W1 and W2 or the first and second wheel brakes WB1 and WB2 are also fluidly connected to the RCU module 20.

In addition, the third and fourth wheel connection flow paths WP3 and WP4 are fluidly connected to the second sub transfer flow path 432 of the IDB module 10. Accordingly, it may be said that the third and fourth wheels W3 and W4 or the third and fourth wheel brakes WB3 and WB4 are also fluidly connected to the IDB module 10.

Accordingly, if the IDB PCB 300 provided in the IDB module 10 malfunctions and the RCU module 20 directly controls the motor 200, a fluid may be supplied to the first and second wheels W1 and W2 or the first and second wheel brakes WB1 and WB2 fluidly connected to the RCU module 20.

Accordingly, even if the IDB PCB 300 malfunctions, rotation of at least the first wheel W1 or the second wheel W2 may be limited. Accordingly, the integrated brake system 1 may stably perform braking of the vehicle.

The RCU valve 800 is disposed on the RCU flow path 700 to control a flow path of a fluid flowing in the RCU flow path 700. The RCU valve 800 may be configured to form or dissipate the flow path of the fluid or control the flow direction of the fluid.

The RCU valve 800 is electrically connected to the RCU PCB 600. The RCU valve 800 may be operated according to a control signal applied by the RCU PCB 600.

The RCU valve 800 is coupled to the RCU flow path 700. The RCU valve 800 may control the flow of the fluid flowing in the RCU flow path 700.

The RCU valve 800 may be provided in any form capable of being operated according to the control signal applied by the RCU PCB 600. In an embodiment, the RCU valve 800 may be provided in the form of a solenoid valve.

A plurality of RCU valves 800 may be provided. The plurality of RCU valves 800 may be provided in each component of the RCU flow path 700 to form and dissipate the flow path or to control the flow direction of the fluid.

In the illustrated embodiment, the RCU valve 800 includes an RCU external valve 810 and an RCU internal valve 820.

The RCU external valve 810 is positioned in the RCU external flow path 710.

The RCU external valve 810 is positioned in a portion of the RCU external flow path 710 connected to the module connection flow path MP.

The RCU external valve 810 may open or close the RCU external flow path 710. In an embodiment, the RCU external valve 810 may be provided as a NC valve. In the above embodiment, in the first situation, the RCU external valve 810 may close the RCU external flow path 710. In the second situation, the RCU external valve 810 may open the RCU external flow path 710.

The RCU internal valve 820 is positioned in the RCU internal flow path 720. The RCU internal valve 820 may permit or block communication between the RCU internal flow path 720 and the RCU external flow path 710 or the direct flow path 900. In addition, the RCU internal valve 820 may permit or block communication between the plurality of RCU internal flow paths 720.

The RCU internal valve 820 may open or close the RCU internal flow path 720. In an embodiment, the RCU internal valve 820 may be provided as an NC valve. In the above embodiment, in the first situation, the RCU internal valve 820 may close the RCU internal flow path 720. In the second situation, the RCU internal valve 820 may open the RCU internal flow path 720.

A plurality of RCU internal valves 820 may be provided. The plurality of RCU internal valves 820 may open or close the RCU internal valve 820 at different positions. In the illustrated embodiment, four RCU internal valves 820 are provided. The pair of RCU internal valves 820 may permit or block communication between the RCU internal flow path 720 and the direct flow path 900. The other pair of RCU internal valves 820 may permit or block communication between the RCU internal flow path 720 and the RCU external flow path 710.

A plurality of RCU internal valves 820 may be independently controlled from each other. The plurality of RCU internal valves 820 may be independently opened or closed, and thus a hydraulic pressure for flowing a fluid may be formed in the RCU internal flow path 720. Accordingly, a separate component for forming the hydraulic pressure is not required for the RCU module 20.

Referring back to FIGS. 1 to 6, the integrated brake system 1 according to an embodiment of the present disclosure includes a direct flow path 900.

The direct flow path 900 fluidly connects the IDB module 10 and the RCU module 20. The direct flow path 900 constitutes a separate flow path from the IDB flow path 400 and the RCU flow path 700 described above. The fluid may be directly transferred to the RCU flow path 700 through the direct flow path 900.

The direct flow path 900 is fluidly connected to the motor 200. Specifically, the direct flow path 900 is fluidly connected to the motor 200 by the motor flow path 410. In addition, the direct flow path 900 is fluidly connected to the RCU emergency flow path 730.

If the IDB PCB 300 malfunctions, the motor 200 may be controlled by the RCU PCB 600. The fluid contained in the motor 200 may flow to the RCU emergency flow path 730 through the direct flow path 900.

As the direct flow path 900 is provided, even if the IDB PCB 300 malfunctions, a minimum fluid for braking the vehicle may be transferred to the RCU module 20 and the wheel W (or wheel brake WB). Accordingly, a separate flow path connecting the previously provided reservoir R and the RCU module 20 is not required to prepare for an emergency situation.

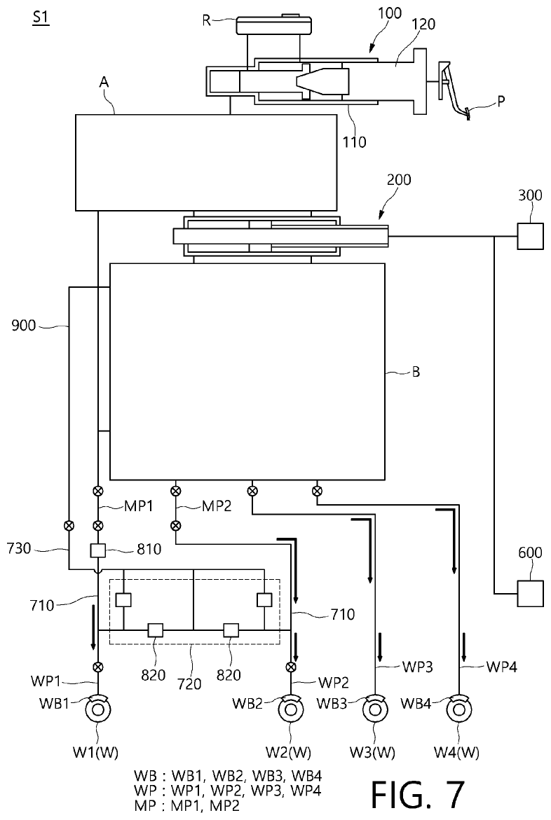

Referring to FIGS. 7 to 10, a flow F of a fluid formed in the integrated brake system 1 according to an embodiment of the present disclosure is illustrated as an example.

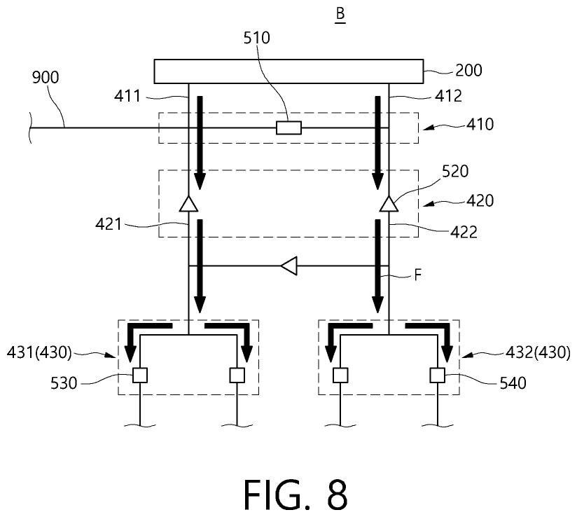

Referring to FIGS. 7 and 8, a flow F of a fluid when the integrated brake system 1 according to an embodiment of the present disclosure operates in a first state S1 is illustrated. The first state S1 is a state in which the IDB PCB 300 is normally operated, and the motor 200 is controlled by the IDB PCB 300 in the first state S1.

When the motor 200 operates and the hydraulic pressure is formed, the fluid flows in the motor flow path 410, the main transfer flow path 420, and the sub transfer flow path 430 in sequence to be transferred to the RCU module 20.

In this case, the fluid flowing along the first motor flow path 411 flows to the first and second module connection flow paths MP1 and MP2 through the first main transfer flow path 421 and the first sub transfer flow path 431 in sequence. The fluid flowing along the first and second module connection flow paths MP1 and MP2 flows to the first and second wheel connection flow paths WP1 and WP2 through the RCU external flow path 710 and the RCU internal flow path 720.

The fluid flowing along the first and second wheel connection flow paths WP1 and WP2 may be flowed to the first and second wheel brakes WB1 and WB2 to limit rotation of the first and second wheels W1 and W2.

In addition, the fluid flowing along the second motor flow path 412 flows to the third and fourth module connection flow paths MP3 and MP4 through the second main transfer flow path 422 and the second sub transfer flow path 432 in sequence. The fluid flowing along the third and fourth module connection flow paths MP3 and MP4 flows to the third and fourth wheel connection flow paths WP3 and WP4.

The fluid flowing along the third and fourth wheel connection flow paths WP3 and WP4 may be flowed to the third and fourth wheel brakes WB3 and WB4 to limit rotation of the third and fourth wheels W3 and W4.

Thus, in the first state S1, the fluid may limit rotation of all of first to fourth wheels W1, W2, W3, and W4.

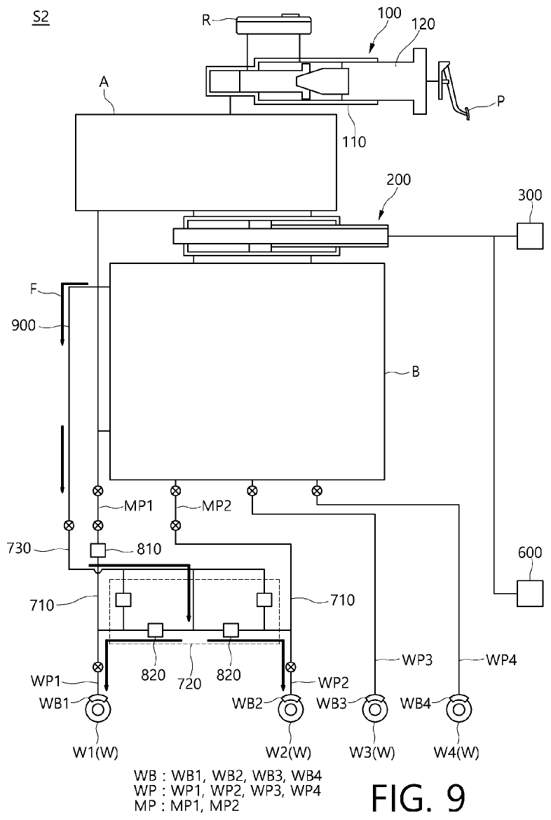

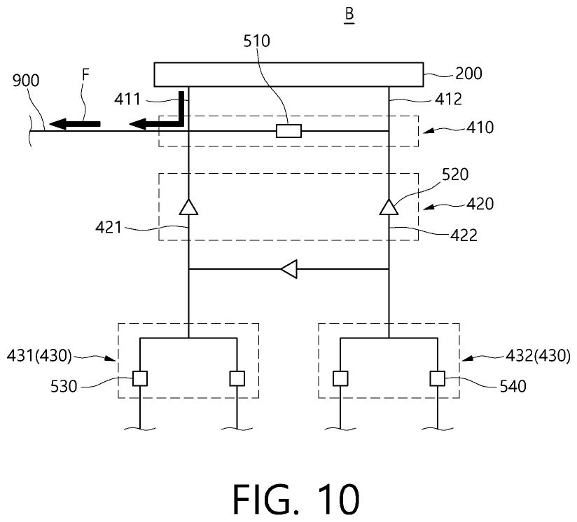

Referring to FIGS. 9 and 10, a flow F of a fluid when the integrated brake system 1 according to the embodiment of the present disclosure is operated in the second state S2 is illustrated. The second state S2 is a state in which the IDB PCB 300 is malfunctioning, and the motor 200 is controlled by the RCU PCB 600 in the second state S2.

When the motor 200 is operated by the RCU PCB 600 to form a hydraulic pressure, the fluid flows to the motor flow path 410 and the direct flow path 900 in sequence to be transferred to the RCU module 20.

In this case, the direct flow path 900 is fluidly connected to the RCU emergency flow path 730. The fluid flowing along the direct flow path 900 flows to the RCU internal flow path 720 through the RCU emergency flow path 730. The fluid flows to the first and second wheel connection flow paths WP1 and WP2 through the RCU external flow path 710 fluidly connected to the RCU internal flow path 720.

The fluid flowing along the first and second wheel connection flow paths WP1 and WP2 may be flowed to the first and second wheel brakes WB1 and WB2 to limit rotation of the first and second wheels W1 and W2.

In this case, as the IDB PCB 300 is malfunctioning, the IDB valve 500 may also be in a state in which the control is impossible. Thus, the fluid is not transferred to the third and fourth wheel connection flow paths WP3 and WP4 that are directly fluidly connected to the IDB module 10.

That is, even if the IDB PCB 300 is malfunctioning in the second state S2, the rotation of at least the first and second wheels W1 and W2 may be limited. Thus, since a minimum fluid necessary for braking the vehicle may be stably supplied, braking of the vehicle may be reliably performed.

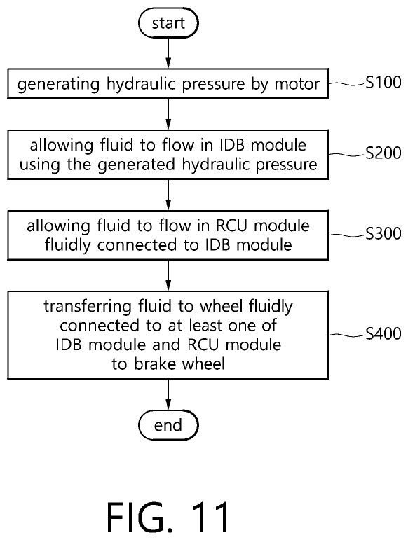

Referring to FIGS. 11 to 15, a method of controlling the integrated brake system 1 according to an embodiment of the present disclosure is illustrated as an example. The control method of the integrated brake system 1 according to the illustrated embodiment may be performed by each component of the integrated brake system 1 described above.

Referring to FIG. 11, a method of controlling the integrated brake system 1 according to the illustrated embodiment includes a step of generating, with a motor 200, hydraulic pressure (S100), a step of allowing a fluid to flow in an IDB module 10 using the generated hydraulic pressure (S200), a step of allowing the fluid to flow in an RCU module 20 fluidly connected to the IDB module 10 (S300), and a step of transferring the fluid to a wheel W fluidly connected to at least one of the IDB module 10 and the RCU module 20 to brake the wheel W (S400).

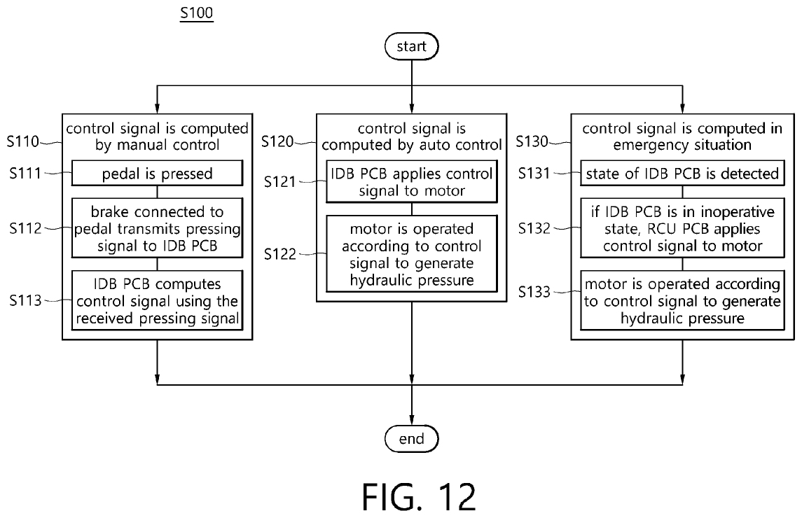

Referring to FIG. 12, a detailed flow of step S100 in which the motor 200 generates hydraulic pressure is illustrated. In this step S100, the motor 200 is controlled to generate a hydraulic pressure for flowing fluid according to a user's operation or a detected driving environment (S100).

This step S100 may be variously configured according to a situation in which a control signal for controlling the motor 200 is computed.

First, a step S110 in which the control signal is computed by a manual control of a user may be considered.

If the pedal P is pressed by the user (S111), the piston 120 of the brake 100 connected to the pedal P is moved, and the pressing signal indicating that the piston 120 has been moved by the pressing of the brake 100 is transmitted to the IDB PCB 300 (S112). As described above, the brake 100 may be electrically connected to the IDB PCB 300.

The IDB PCB 300 computes the control signal using the received pressing signal (S113). The IDB PCB 300 may control the motor 200 according to the calculated control signal to generate the hydraulic pressure.

In addition, in the state in which the IDB PCB 300 is normally operated, the step S120 in which the control signal is computed by an auto control may be considered.

Using information on a driving environment acquired by a sensor or the like, the IDB PCB 300 computes the control signal and applies the control signal to the motor 200 (S121). The motor 200 is operated according to the applied control signal to generate the hydraulic pressure (S122).

Furthermore, this step S130 of computing the control signal in a state in which the IDB PCB 300 is malfunctioned, may be considered. Here, it will be understood that the step S130 may be applied to both manual control and auto control.

The RCU PCB 600 detects the state of the IDB PCB 300 (S131). The RCU PCB 600 and the IDB PCB 300 may detect the state of each other as described above.

If the IDB PCB 300 is in an inoperative state or a malfunctioned state, the RCU PCB 600 computes the control signal and applies the control signal to the motor 200 (S132). To this end, the RCU PCB 600 is also electrically connected to the motor 200. The motor 200 is operated according to the applied control signal to generate the hydraulic pressure (S133).

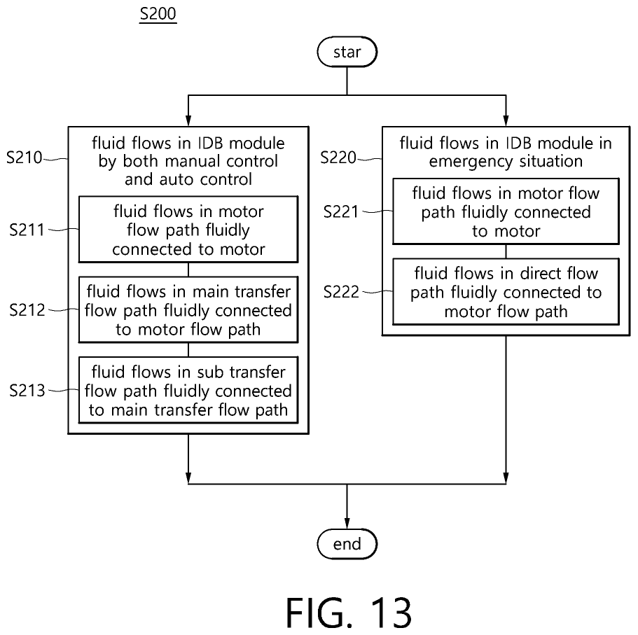

Referring to FIG. 13, a detailed flow of step S200 is shown in which fluid flows in the IDB module 10 by the generated hydraulic pressure. In this step S200, the motor 200 is operated to allow the fluid to flow forward in the IDB module 10.

This step S200 may be variously configured depending on whether the IDB PCB 300 is normally operated.

First, the step S210, in which fluid flows in the IDB module 10 while the IDB PCB 300 is normally operated, may be considered. In this step S210, the IDB valve 500 is controlled by the IDB PCB 300, and the fluid may flow along each component of the IDB flow path 400. It will also be understood that this step S210 may be applied to both manual control and auto control.

The fluid flows in the motor flow path 410 fluidly connected to the motor 200 (S211). The fluid passing through the motor flow path 410 passes through the main transfer flow path 420 fluidly connected to the motor flow path 410 (S212) and flows to the sub transfer flow path 430 fluidly connected to the main transfer flow path 420 (S213).

Next, in a state in which the IDB PCB 300 malfunctions (i.e., an emergency situation), the fluid flows in the IDB module 10 (S220) may be considered. In this step (S220), since the IDB PCB 300 cannot control the IDB valve 500, the fluid may flow directly to the direct flow path 900 via the motor flow path 410. It will be understood that this step (S220) may also be applied to both manual control and auto control.

The fluid flows in the motor flow path 410 fluidly connected to the motor 200 (S221). In this case, the fluid is transferred to the direct flow path 900 fluidly connected to the motor flow path 410 without flowing to the main transfer flow path 420 (S222).

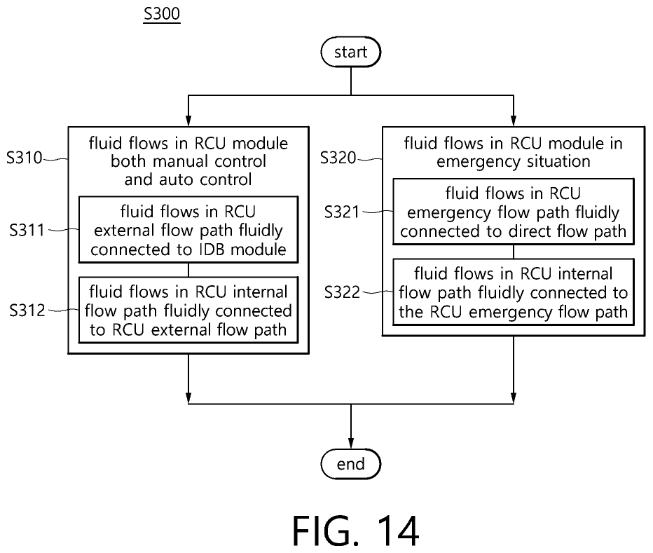

Referring to FIG. 14, a detailed flow of step S300 in which the fluid flows in the RCU module 20 fluidly connected to the IDB module 10 is illustrated. In this step S300, the fluid discharged from the IDB module 10 is transferred to the RCU module 20 by the hydraulic pressure generated by the motor 200 and flows in the RCU module 20.

This step S300 may also be variously configured depending on whether the IDB PCB 300 is normally operated.

First, step S310 in which the IDB PCB 300 is normally operated, and the fluid passes through the main transfer flow path 420 and the sub transfer flow path 430 and is transferred to the RCU module 20 may be considered. It will be understood that this step S310 may be applied to both manual control and auto control.

The fluid passes through the module connection flow path MP fluidly connected to the sub transfer flow path 430 of the IDB module 10 and is transferred to the RCU external flow path 710 (S311). In this case, the fluid flowing in the first sub transfer flow path 431 may be transferred to the RCU external flow path 710 via the first module connection flow path MP1. In addition, the fluid flowing in the second sub transfer flow path 432 may be transferred to the RCU external flow path 710 via the second module connection flow path MP2.

The fluid transferred to the RCU external flow path 710 flows in the RCU internal flow path 720 fluidly connected to the RCU external flow path 710 (S312). In this case, the plurality of RCU internal flow paths 720 provided in the RCU internal flow path 720 are opened and closed, and thus the hydraulic pressure for the fluid to flow is formed as described above.

Next, in a state where the IDB PCB 300 malfunctions (i.e., an emergency situation), the fluid is transferred to the RCU module 20 through the direct flow path 900 (S320) may be considered. It will be understood that this step S320 may also be applied to both manual control and auto control.

The fluid flows along the direct flow path 900 fluidly connected to the motor flow path 410 and then is transferred to the RCU emergency flow path 730 fluidly connected to the direct flow path 900 (S321). The fluid transferred to the RCU emergency flow path 730 flows in the RCU internal flow path 720 fluidly connected to the RCU emergency flow path 730 (S322). In this case, the plurality of RCU internal flow paths 720 provided in the RCU internal flow path 720 are opened and closed, and thus the hydraulic pressure for the fluid to flow is formed as described above.

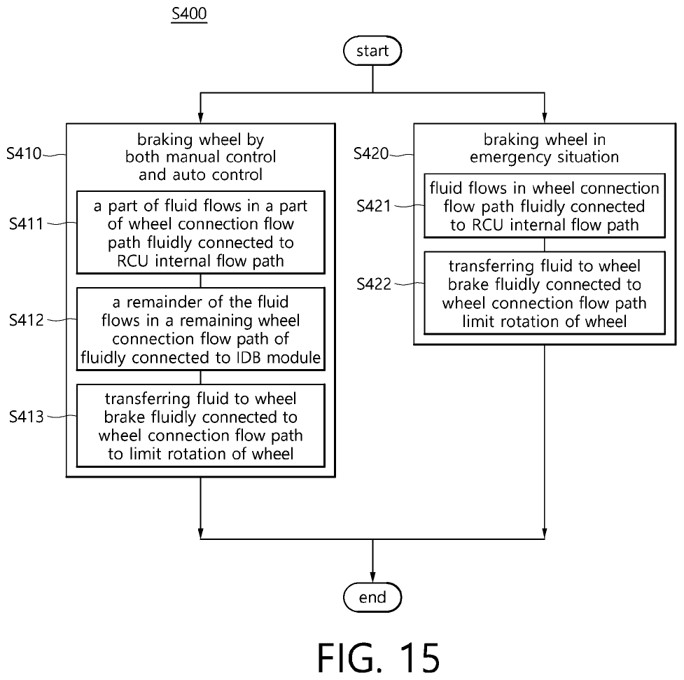

Referring to FIG. 15, a detailed flow of step S400 in which the fluid is transferred to the wheel W fluidly connected to any one or more of the IDB module 10 and the RCU module 20 to brake the wheel W. This step S400 is a step in which the fluid is directly transferred in the IDB module 10 or indirectly via the RCU module 20 to the wheel brake WB so that the rotation of the wheel W is controlled. It will be understood that in this step S400, the braking of the vehicle is controlled.

The present step S400 may also be variously configured depending on whether the IDB PCB 300 is normally operated.

First, it may be considered that the IDB PCB 300 is normally operated so that a part of the fluid is transferred directly from the IDB module 10 to the wheel brake WB through the RCU module 20 (S410). It will be understood that this step S410 may be applied to both manual control and auto control.

A part of the fluid flows to a portion of the plurality of wheel connection flow paths WP through the RCU external flow path 710 fluidly connected to the RCU internal flow path 720. As described above, in an embodiment, a portion of the fluid may flow to the first and second wheel connection flow paths WP1 and WP2 fluidly connected to the RCU external flow path 710.

Further, the remainder of the fluid flows to the remainder of the plurality of wheel connection flow paths WP, which are fluidly connected to the second sub transfer flow path 432 of the IDB module 10 (S412). As described above, in an embodiment, the remainder of the fluid may flow to the third and fourth wheel connection flow paths WP3 and WP4 fluidly connected to the second sub transfer flow path 432.

The fluid flowing into the wheel connection flow paths WP1, WP2, WP3, and WP4 is transferred to the wheel brakes WB1, WB2, WB3, and WB4 fluidly connected to the wheel connection flow paths WP1, WP2, WP3, and WP4, thereby limiting the rotation of the wheels W1, W2, W3, and W4 (S413). Accordingly, the vehicle may be braked.

Further, step S420 in which the IDB PCB 300 malfunctions and thus the fluid is transferred to the wheel brake WB only through the RCU module 20 may be considered. It will be understood that this step S420 may also be applied to both manual control and auto control.

The fluid flowing to the RCU internal flow path 720 via the direct flow path 900 and the RCU emergency flow path 730 flows to a part of the plurality of wheel connection flow paths WP via the RCU external flow path 710 (S421). As described above, in an embodiment, the fluid may flow to the first and second wheel connection flow paths WP1 and WP2 connected to the RCU external flow path 710 among the plurality of wheel connection flow paths WP.

The fluid flowing along a part of the wheel connection flow path WP is transferred to the wheel brake WB fluidically connected to the wheel connection flow path WP to limit the wheel W (S422). In an embodiment, the fluid may be transferred to the first and second wheel brakes WB1 and WB2 via the first and second wheel connection flow paths WP1 and WP2, thereby limiting the rotation of the first and second wheels W1 and W2. Accordingly, the vehicle may be braked.

Accordingly, according to an embodiment of the present disclosure, even if the IDB PCB 300 is malfunctioned, a minimum fluid required for braking the vehicle may be supplied. Accordingly, braking of the vehicle may be reliably performed, and safety of the driver or the passenger may also be improved.

Although the present disclosure has been described, the spirit of the present disclosure is not limited by the embodiments presented herein, and those skilled in the art who understand the spirit of the present disclosure can easily propose other embodiments by addition, modification, deletion, addition, etc. of components within the same spirit, but these are also within the spirit of the present disclosure.

### EXPLANATION OF REFERENCE NUMERALS

| | |
|---|---|
| 1: integrated brake system | 10: IDB module |
| 20: RCU module | 100: brake |
| 110: cylinder | 120: piston |
| 130: brake flow path | 140: brake valve |
| 200: motor | 300: IDB PCB |
| 400: IDB flow path | 410: motor flow path |
| 411: first motor flow path | 412: second motor flow path |
| 420: main transfer flow path | 421: first main transfer flow path |
| 422: second main transfer flow path | 430: sub transfer flow path |
| 431: first sub transfer flow path | 432: second transfer flow path |
| 500: IDB valve | 510: main NC valve |
| 520: main check valve | 530: first sub NC valve |
| 540: second sub NC valve | 600: RCU PCB |
| 700: RCU flow path | 710: RCU external flow path |
| 720: RCU internal flow path | 730: RCU emergency flow path |
| 800: RCU valve | 810: RCU external valve |
| 820: RCU internal valve | 900: direct flow path |
| P: pedal | W: wheel |
| W1: first wheel | W2: second wheel |
| W3: third wheel | W4: fourth wheel |
| R: reservoir | MP: module connection flow path |
| MP1: first module connection flow | MP2: second module connection |
| path | flow path |
| WP: wheel connection flow path | WP1: first wheel connection flow |
| | path |
| WP2: second wheel connection flow | WP3: third wheel connection flow |
| path | path |
| WP4: fourth wheel connection flow | WB: wheel brake |
| path | |
| WB1: first wheel brake | WB2: second wheel brake |
| WB3: third wheel brake | WB4: fourth wheel brake |
| F: flow of fluid | S1: first state |
| S2: second state | |

What is claimed is:

1. An integrated brake system comprising:
a remote control utility (hereinafter, referred to as “RCU”) module fluidly connected to a wheel brake coupled to a wheel; and
an integrated dynamic brake (hereinafter, referred to as “IDB”) module fluidly connected to the RCU module and providing a transfer force to a fluid to be transferred to the wheel brake, and
the IDB module comprising:
a motor providing the transfer force to the fluid; and
an IDB PCB electrically connected to the motor to control the motor, and
the RCU module comprising:
an RCU PCB electrically connected to the motor to control the motor based on an inoperable state of the IDB PCB.

2. The integrated brake system of claim 1, wherein
the IDB module comprises:
an IDB flow path fluidly connected to the motor and through which the fluid flows; and
an IDB valve positioned in a part of the IDB flow path and electrically connected to the IDB PCB and controlled by the IDB PCB, and
wherein the RCU module comprises
an RCU flow path fluidly connected to the IDB flow path and the wheel brake and through which the fluid flows.

3. The integrated brake system of claim 2, the system comprising:
a direct flow path fluidly connected to another part of the IDB flow path and the RCU flow path to constitute a passage through which the fluid flows to the RCU flow path via the other portion of the IDB flow path.

4. The integrated brake system of claim 2, wherein the IDB flow path comprises:
a motor flow path fluidly connected to the motor;
a main transfer flow path fluidly connected to the motor flow path and having a part of the IDB valve positioned thereon; and
a sub transfer flow path fluidly connected to the main transfer flow path and the RCU flow path and having another part of the IDB valve positioned thereon.

5. The integrated brake system of claim 4, the system comprising:
a direct flow path fluidly connected to the motor flow path, and
wherein the RCU module comprises
an RCU emergency flow path fluidly connected to the direct flow path.

6. The integrated brake system of claim 1, the system comprising:
a direct flow path fluidly connecting the motor and the RCU module,
wherein the RCU module comprises:
an RCU external flow path fluidly connected to an IDB flow path of the IDB module;
an RCU internal flow path fluidly connected to the RCU external flow path and the wheel brake, respectively; and
an RCU emergency flow path fluidly connected to the direct flow path.

7. The integrated brake system of claim 6, wherein the RCU module comprises
an RCU internal valve disposed in the RCU internal flow path and
configured to partially open and close the RCU internal flow path to form a hydraulic pressure that causes the fluid to flow.

8. The integrated brake system of claim 1, wherein the IDB module comprises a brake coupled to a pedal and electrically connected to the IDB PCB, and
the IDB PCB computes a control signal for controlling the motor using a pressing signal generated by pressing the pedal.

9. The integrated brake system of claim 8, wherein the brake comprises:
a piston coupled to the pedal;
a cylinder movably accommodating the piston and containing the fluid therein; and
a brake flow path fluidly connected to the cylinder and the RCU module, respectively, to constitute a flow path through which the fluid flows to the RCU module.

10. The integrated brake system of claim 9, wherein the brake comprises
a brake valve positioned on the brake flow path and configured to control a flow direction of the fluid such that the fluid flows only in the direction from the cylinder toward the RCU module.

11. A method for controlling an integrated brake system, the method comprising:
(a) generating, with a motor, a hydraulic pressure;
(b) allowing a fluid to flow in an IDB module using the generated hydraulic pressure;
(c) allowing the fluid to flow in an RCU module fluidly connected to the IDB module; and
(d) transferring the fluid to a wheel fluidly connected to at least one of the IDB module and the RCU module to brake the wheel,
wherein the motor is controlled by at least one of an IDB PCB provided in the IDB module and an RCU PCB provided in the RCU module.

12. The method of claim 11, wherein (a) generating the hydraulic pressure comprises:
(a1) applying, with the IDB PCB, a control signal to the motor; and
(a2) operating the motor according to the control signal to generate the hydraulic pressure.

13. The method of claim 12, wherein (a) generating the hydraulic pressure further comprises: before (a1) applying the control signal to the motor,
(a01) pressurizing a pedal; and
(a02) transmitting a pressing signal to the IDB PCB using a brake connected to the pedal, wherein the IDB PCB computes the control signal using the pressing signal applied.

14. The method of claim 11, wherein (a) generating the hydraulic pressure comprises:
(a3) detecting a state of the IDB PCB;
(a4) applying, with the RCU PCB, a control signal to the motor if the IDB PCB is in an inoperable state; and
(a5) operating the motor according to the control signal to generate the hydraulic pressure.

15. The method of claim 11, wherein (b) allowing the fluid to flow in the IDB module comprises:
(b1) allowing the fluid to flow in a motor flow path fluidly connected to the motor;
(b2) allowing the fluid to flow in a main transfer flow path fluidly connected to the motor flow path; and
(b3) allowing the fluid to flow in a sub transfer flow path fluidly connected to the main transfer flow path.

16. The method of claim 11, wherein (b) allowing the fluid to flow in the IDB module comprises:
(b4) allowing the fluid to flow in a motor flow path fluidly connected to the motor; and
(b5) allowing the fluid to flow in a direct flow path fluidly connected to the motor flow path.

17. The method of claim 11, wherein (c) allowing the fluid to flow in the RCU module comprises:
(c1) allowing the fluid to flow in an RCU external flow path fluidly connected to the IDB module; and
(c2) allowing the fluid to flow in an RCU internal flow path fluidly connected to the RCU external flow path.

18. The method of claim 11, wherein (c) allowing the fluid to flow in the RCU module comprises:
(c3) allowing the fluid to flow in an RCU emergency flow path fluidly connected to the direct flow path; and
(c4) allowing the fluid to flow in an RCU internal flow path fluidly connected to the RCU emergency flow path.

19. The method of claim 11, wherein (d) transferring the fluid to the wheel comprises:
(d1) allowing a part of the fluid to flow in a part of a wheel connection flow path fluidly connected to an RCU internal flow path;
(d2) allowing a remainder of the fluid to flow in a remaining wheel connection flow path of fluidly connected to the IDB module; and
(d3) transferring the fluid to a wheel brake fluidly connected to the wheel connection flow path to limit rotation of the wheel.

20. The method of claim 11, wherein (d) transferring the fluid to the wheel comprises:
(d4) allowing the fluid to flow in a wheel connection flow path fluidly connected to a RCU internal flow path; and
(d5) transferring the fluid to a wheel brake fluidly connected to the wheel connection flow path to limit rotation of the wheel.
